(19) United States
(12) Patent Application Publication
(10) Pub. No.: US 2012/0137880 A1
(43) Pub. Date: Jun. 7, 2012

(54) System and Method for Removing Undesirables from a Gas

(75) Inventors: Elbert R. Butterworth, Weston Lakes, TX (US); Henry N. Myrick, Houston, TX (US)

(73) Assignee: CAPID INC. LLC, Weston Lakes, TX (US)

(21) Appl. No.: 13/147,366

(22) PCT Filed: Jan. 26, 2010
(86) PCT No.: PCT/US10/22076

§ 371 Date: Sep. 20, 2011

Related U.S. Application Data
(60) Provisional application No. 61/149,237, filed on Feb. 2, 2009.

(51) Int. Cl. B01D 53/02

(52) U.S. Cl. 95/90; 96/108

(57) ABSTRACT

A system and method remove undesirables from a gas produced by a combustion chamber. The system includes a first addition point, wherein treatment materials are added to the gas in a first addition temperature zone. The system also includes a second addition point, wherein treatment materials are added to the gas in a second addition temperature zone. The second addition point is downstream of the first addition point. The first addition temperature zone is at a higher temperature than the second addition temperature zone. The treatment materials remove undesirables from the gas.

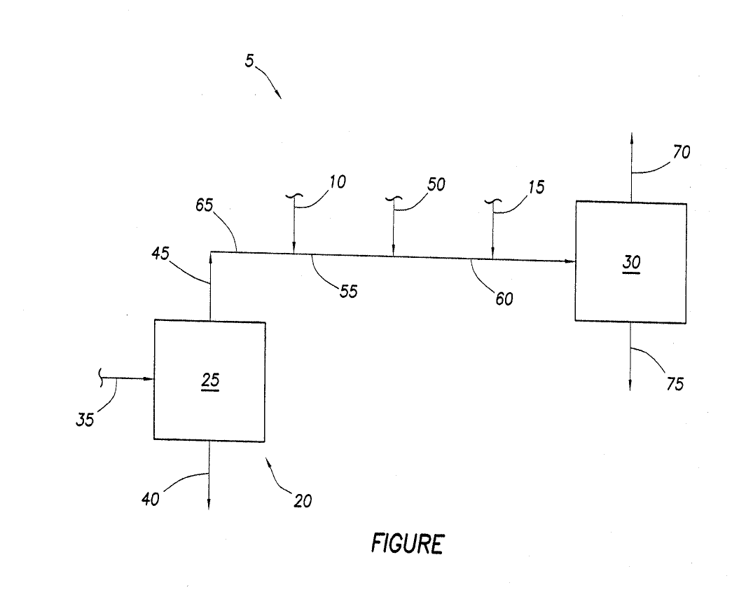

### BACKGROUND OF THE INVENTION

1. Field of the Invention

This invention relates to the field of removing undesirables from a gas and more specifically to removing undesirables from a gas by addition of treatment materials at different temperature points.

2. Background of the Invention

Various methods have been developed for removing undesirables from combustion exhaust gas. In one method, activated carbon particulates are used. For instance, activated carbon particulates may be added to an exhaust stream, with the activated carbon particulates typically bonding with the undesirables and thereby allowing them to be removed. Drawbacks to such method include that the typically high temperature of unprocessed exhaust gases ignites activated carbon. To overcome such ignition issues, methods have been developed by which the carbon particulate has been added after the exhaust gases are cooled to 100° C. to 200° C. Drawbacks to such methods include inefficiencies in the chemical bonding process. Further drawbacks to using activated carbon particulates include that the activated carbon is a black powder, which is typically inefficient to handle. Additional drawbacks include that activated carbon particulates typically contain an acid residue, which may be corrosive to the metals in the entire system and which may thereby be more difficult to transport and store. Moreover, drawbacks to activated carbon particulates include that the result of the method using activated carbon particulates is a black spent cake that is typically disposed of in a landfill that accepts heavy metals, which landfills are typically more expensive than conventional landfills.

Further methods for removing undesirables from a gas include the addition of further air pollution control equipment to the facility or process. Drawbacks to such methods include that the addition process is typically very expensive and time consuming.

Consequently, there is a need for an improved method of removing undesirables from a gas. Additional needs include improved methods of removing undesirables from a gas with minimal influence on the environment.

### BRIEF SUMMARY OF SOME OF THE PREFERRED EMBODIMENTS

These and other needs in the art are addressed in one embodiment by a system for removing undesirables from a gas produced by a combustion chamber. The system includes a first addition point, wherein treatment materials are added to the gas in a first addition temperature zone. The system also includes a second addition point, wherein treatment materials are added to the gas in a second addition temperature zone. The second addition point is downstream of the first addition point. The first addition temperature zone is at a higher temperature than the second addition temperature zone. The treatment materials remove undesirables from the gas.

These and other needs in the art are addressed in another embodiment by a method for removing undesirables from a gas produced in a combustion chamber. The method includes adding treatment materials to the gas at a first addition point, wherein the first addition point is disposed in a first addition temperature zone. The method also includes adding treatment materials to the gas at a second addition point, wherein the second addition point is disposed in a second addition zone. The second addition point is downstream of the first addition point. The first addition temperature zone is at a higher temperature than the second addition temperature zone. The treatment materials remove undesirables from the gas.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawing in which a gas treatment process has a first addition point and a second addition point.

### DETAILED DESCRIPTION OF THE PREFERRED EMBODIMENTS

The FIGURE illustrates an embodiment of a gas treatment process 5 having first addition point 10 and second addition point 15. First addition point 10 and second addition point 15 each represent addition points of treatment materials that treat gas 45. Gas 45 may be any gas produced during combustion processes of such commercial operations. Without limitation, such commercial operations include coal-fired electricity generation, metal production, industrial waste handling, hazardous waste handling, metal production, metal regeneration, and the like. In an embodiment, gas 45 is an exhaust gas from such commercial operations. Gas 45 includes undesirables. Without limitation, undesirables include heavy metals such as mercury and cadmium, non-combusted materials, combustion by-products such as dioxins and furans, radio nuclei, fine particulates, and the like.

In embodiments, gas treatment process 5 treats gas 45 to remove undesirables from gas 45. In relation to the flow of gas 45, first addition point 10 is upstream from second addition point 15. At first addition point 10 and second addition point 15, treatment materials are added to gas 45 at different gas 45 temperature zones. The temperature zone at which treatment materials are added at first addition point 10 is first addition temperature zone 55, and the temperature zone at which treatment materials are added at second addition point 15 is second addition temperature zone 60. First addition temperature zone 55 is at a higher temperature than second addition temperature zone 60. In embodiments, a coolant gas 50 is added between first addition point 10 and second addition point 15. Coolant gas 50 is any gas that is non-reactive with gas 45 and suitable for cooling gas 45. In some embodiments, coolant gas 50 is ambient air. In embodiments, the feed rate of coolant gas 50 is controlled to cool gas 45 to a desired temperature.

The treatment materials added at first addition point 10 and at second addition point 15 include adsorbents, absorbents, or any combinations thereof Adsorbents may include any adsorbents suitable for adsorbing undesirables and for use with gas 45. In embodiments, the adsorbents include activated clay, non-activated clay, activated silicates, non-activated silicates, zeolites, silicas, metal oxides, metal hydroxides, or any combinations thereof. In an embodiment, metal oxides include magnesium oxide, aluminum oxide, titanium oxide, or any combinations thereof. In embodiments, the adsorbents do not include activated carbon. Absorbents may include any absorbents suitable for absorbing undesirables and for use with gas 45. In embodiments, the absorbents include diatomaceous earth, perlite, zeolites, silica, or any combinations thereof In an embodiment, the absorbents and adsorbents are in powder form. It is to be understood that in some instances the treatment materials selected allow the undesirables to be removed on a nano-scale.

In some embodiments, the treatment materials are a mixture of adsorbents and absorbents. In such embodiments, the treatment materials include any ratio of adsorbent to absorbent suitable for removing the undesirables from gas 45. In some embodiments, the treatment materials include a weight ratio of adsorbent to absorbent of about 2:3 to about 3:2, alternatively about 1:4 to about 4:1, and alternatively about 1:1.

Since each application may be different from other applications, in some embodiments, the addition rate of the treatment materials added at first addition point 10 and second addition point 15 is correlated to the amount of undesirables to be removed from gas 45. In alternative embodiments, the addition rate of the treatment materials added at first addition point 10 or second addition point 15 is correlated to the amount of undesirables to be removed from gas 45. The addition rates may be correlated by any suitable means. In an embodiment, gas 45 is analyzed for amounts and types of undesirables and the production rate of gas 45. From the results of such analysis, the addition rates of the treatment materials are selected. In alternative embodiments, if the addition of first addition point 10 provides sufficient absorption, adsorption, and/or collection of undesirables, such alternative embodiments of gas treatment process 5 do not include adding treatment materials at second addition point 15.

In an embodiment, the adsorbents and/or absorbents added at first addition point 10 and/or second addition point 15 are selected for compatibility with the temperature and undesirables of gas 45 in first addition temperature zone 55 and second addition temperature zone 60. Without limitation, such selection improves adsorption, absorption, and/or agglomeration of the undesirables. Therefore, such selection facilitates removal of undesirables downstream in production process 20 (i.e., by air pollution control system 30). In embodiments, the selection of materials provides a synergism between treatment materials added at first addition point 10 and second addition point 15. For instance, a combination of adsorbents and/or absorbents in the treatment materials added at first addition point 10 may affect a particular adsorption, absorption, and/or collection, and a combination of adsorbents and/or absorbents in the treatment materials added at second addition point 15 may affect a different adsorption, absorption, and/or collection with the combined affect of the adsorption, absorption, and/or collection by the treatment materials added at first addition point 10 and second addition point 15 providing a greater adsorption, absorption, and/or collection than either of the treatment materials individually. In an embodiment, the treatment materials at first addition point 10 and second addition point 15 are the same. In alternative embodiments, different treatment materials are added at first addition point 10 and second addition point 15.

The FIGURE illustrates an embodiment of gas treatment process 5 and production process 20 in which production process 20 includes combustion chamber 25 and air pollution control system 30. Combustion chamber 25 may include any type of combustion chamber that produces a gas 45. For instance, without limitation, combustion chamber 25 may include furnaces, coal fired boilers and the like. In an embodiment as illustrated, combustion chamber 25 is a coal fired boiler. Air pollution control system 30 may be any air pollution control system and equipment suitable for controlling air pollution of a gas 45. For instance, without limitation, air pollution control system 30 may include a bag house, electrostatic precipitator, wet/dry scrubber, and the like. In an embodiment, air pollution control system 30 includes a bag house.

In an embodiment of operation of such embodiments of the FIGURE, furnace feed 35 is fed to combustion chamber 25 and combusted. Furnace feed 35 is any feed suitable for the desired production of combustion chamber 25. For instance, in an embodiment in which combustion chamber 25 is a coal fired boiler, furnace feed 35 may be coal and lime. Combustion chamber 25 ignites furnace feed 35 producing furnace heavies 40 and gas 45. In an embodiment in which combustion chamber 25 is a coal fired boiler, furnace heavies 40 are bottom ash, and gas 45 is the combustion flue gas. In such an embodiment, gas 45 exits combustion chamber 25 and is directed to air pollution control system 30 through furnace ductwork 65. Treatment materials are added to ductwork 65 of first addition temperature zone 55 at first addition point 10, with the treatment materials removing undesirables from gas 45 (i.e., by adsorption, absorption, and/or collection (i.e., agglomeration)). In an embodiment, first addition point 10 is disposed in ductwork 65 proximate to combustion chamber 25. Without limitation, in such embodiment, first addition point 10 is disposed as close to combustion chamber 25 as feasible. Without being limited by theory, such proximity provides more contact and mixing of the treatment materials with gas 45 than if disposed downstream closer to coolant gas 50. Such contact and mixing facilitates removal of undesirables from gas 45. Coolant gas 50 is added to gas 45 to cool gas 45 to a desirable temperature. For instance, in embodiments in which combustion chamber 25 is a coal fired boiler, some embodiments include a gas 45 temperature in first addition temperature zone 55 of between about 500° F. and 700° F., alternatively about 600° F. In such embodiments, a sufficient amount of coolant gas 50 is added to gas 45 to reduce the temperature of gas 45 in second addition temperature zone 60 to a temperature from about 200° F. to about 400° F., alternatively from about 350° F. to about 400° F., and alternatively about 350° F. Treatment materials are added to ductwork 65 of second addition temperature zone 60 at second addition point 15, which is at a desired location between coolant gas 50 and air pollution control system 30. In some embodiments, second addition point 15 is proximate the location of addition of coolant gas 50. Without limitation, locating second addition point 15 at a location distal to air pollution control system 30 and proximate to coolant gas 50 facilitates mixing of the treatment materials with gas 45. The treatment materials remove undesirables from gas 45. Gas 45 from second addition temperature zone 60 is fed to air pollution control system 30. Air pollution control system 30 removes the treatment materials with the adsorbed, absorbed, and/or collected undesirables. The removed treatment materials with the adsorbed, absorbed, and/or collected undesirables exit air pollution control system 30 as air pollution control system solids 75. The remaining portion exits air pollution control system 30 as air pollution control system fluids 70. It is to be understood that the contents of air pollution control system fluids 70 and air pollution control system solids 75 depends on the type of air pollution control system 30 used. For instance, in an embodiment in which air pollution control system 30 is a bag house, air pollution control system fluids 70 is a vent gas, and air pollution control system solids 75 is top ash. In an embodiment in which air pollution control system 30 is a wet scrubber, air pollution control system solids 75 is the solid residue, and air pollution control system fluids 70 is the liquid portion. In such an embodiment, the solid residue may be dried before storing. If the liquid portion contains some undesirables, the undesirables may be removed from the liquid by any suitable means such as by a continuous filtration operation.

The treatment materials may be added to ductwork 65 by any suitable means. In an embodiment, the treatment materials are added by injection into ductwork 65. For instance, a hole may be cut into ductwork 65 at first addition point 10, and another hole may be cut into ductwork 65 at second addition point 15. The treatment materials may be added through the holes. In some embodiments, the treatment materials are added at first addition point 10 and/or second addition point 15 at an angle to ductwork 65 or other piping by which gas 45 passes therethrough. Adding the treatment materials into gas 45 at an angle provides a swirling action of the treatment materials in ductwork 65 or other piping. Such swirling action improves contact of the treatment materials with undesirables in the gas. In an embodiment, the angle at which the treatment materials are added is greater than 0 degrees and less than 90 degrees to ductwork 65 or other piping.

In an embodiment in which the treatment materials are injected in ductwork 65 or other piping, an injector device (not illustrated) is used. In an embodiment, the injector device is a device suitable for injection at high temperatures and also for overcoming the pressure in ductwork 65 or other piping. In embodiments, the injector device is a rotary valve.

In some embodiments in which air pollution control system solids 75 are top ash, the top ash may be encapsulated. For instance, in some instances, the undesirables include radio nuclei. The top ash containing radio nuclei removed from gas 45 by gas treatment process 5 may be desired to be encapsulated. Without limitation, such encapsulation allows disposal of the top ash without harming the environment.

In other embodiments, the products of air pollution control system 30 may be used in other processes. For instance, in an embodiment in which air pollution control system solids 75 are top ash, the top ash may be used as an additive for other processes such as cement operations, clay operations, or the like. In some embodiments, the treatment materials in the top ash act as a position in cement operations, which facilitates setting of the cement.

Although the present invention and its advantages have been described in detail, it should be understood that various changes, substitutions and alterations may be made herein without departing from the spirit and scope of the invention as defined by the appended claims.

What is claimed is:

1. A system for removing undesirables from a gas produced by a combustion chamber, comprising:
a first addition point, wherein treatment materials are added to the gas in a first addition temperature zone;
a second addition point, wherein treatment materials are added to the gas in a second addition temperature zone, and wherein the second addition point is downstream of the first addition point, and further wherein the first addition temperature zone is at a higher temperature than the second addition temperature zone; and
wherein the treatment materials remove undesirables from the gas.

2. The system of claim 1, wherein the treatment materials comprise an absorbent, an adsorbent, or any combinations thereof.

3. The system of claim 2, wherein the adsorbents comprise activated clay, non-activated clay, activated silicates, non-activated silicates, zeolites, silicas, metal oxides, metal hydroxides, or any combinations thereof.

4. The system of claim 2, wherein the absorbents comprise diatomaceous earth, perlite, zeolites, silica, or any combinations thereof.

5. The system of claim 2, wherein the adsorbents do not comprise activated carbon.

6. The system of claim 1, further comprising a coolant gas, wherein the coolant gas is added to the gas between the first addition point and the second addition point.

7. The system of claim 1, wherein the combustion chamber comprises a coal fired boiler.

8. The system of claim 1, wherein the first addition temperature zone is between about 500° F. and about 700° F., and the second addition temperature zone is between about 200° F. and about 400° F.

9. The system of claim 1, wherein the second addition point is disposed upstream of an air pollution control system.

10. The system of claim 1, wherein the treatment materials are added to the gas at an angle.

11. A method for removing undesirables from a gas produced in a combustion chamber, comprising:
(A) adding treatment materials to the gas at a first addition point, wherein the first addition point is disposed in a first addition temperature zone; and
(B) adding treatment materials to the gas at a second addition point, wherein the second addition point is disposed in a second addition zone, and wherein the second addition point is downstream of the first addition point, and further wherein the first addition temperature zone is at a higher temperature than the second addition temperature zone, and wherein the treatment materials remove undesirables from the gas.

12. The method of claim 11, wherein the treatment materials comprise an absorbent, an adsorbent, or any combinations thereof.

13. The method of claim 12, wherein the adsorbents comprise activated clay, non-activated clay, activated silicates, non-activated silicates, zeolites, silicas, metal oxides, metal hydroxides, or any combinations thereof.

14. The method of claim 12, wherein the absorbents comprise diatomaceous earth, perlite, zeolites, silica, or any combinations thereof.

15. The method of claim 11, further comprising reducing the temperature of the gas between the first addition temperature zone and the second addition temperature zone.

16. The method of claim 11, further comprising reducing the temperature of the gas by adding a coolant gas to the gas, wherein the coolant gas is added between the first addition point and the second addition point.

17. The method of claim 11, wherein the treatment materials are added at the first addition point at a first addition rate, and the treatment materials are added at the second addition point at a second addition rate, further comprising correlating the first addition rate and the second addition rate to an amount of undesirables to be removed from the gas.

18. The method of claim 11, wherein the second addition point is disposed upstream of an air pollution control system.

19. The method of claim 11, wherein the treatment materials are added to the gas at an angle.

20. The method of claim 11, wherein the first addition point is proximate to the combustion chamber.
